(19) United States
(12) Patent Application Publication
(10) Pub. No.: US 2010/0311605 A1
(43) Pub. Date: Dec. 9, 2010

(54) SENSING PLATFORM

(75) Inventors: Chih-Sheng Lin, Hsinchu (TW); Yao-Chen Chuang, Hsinchu (TW); Sz-Hao Chen, Hsinchu (TW)

Correspondence Address: EDWARDS ANGELL PALMER & DODGE LLP, P.O. BOX 55874, BOSTON, MA, 02205, US

(73) Assignee: NATIONAL CHIAO TUNG UNIVERSITY, Hsinchu (TW)

(21) Appl. No.: 12/567,192

(22) Filed: Sep. 25, 2009

(30) Foreign Application Priority Data
Jun. 3, 2009 (TW) 98118317

(51) Int. Cl. C40B 30/04; C40B 40/18; C40B 40/04; C40B 40/10; C40B 40/06; C40B 50/08

(52) U.S. Cl. 506/9; 506/22; 506/15; 506/18; 506/16; 506/27

(57) ABSTRACT

A sensing platform includes: a plurality of metal nanoparticles; a plurality of aggregate inducers each comprising first and second functional groups different from each other, and the first functional group of the aggregate inducers being in contact with the metal nanoparticles; and a plurality of recognition molecules for binding the metal nanoparticles and for interacting with a target to recognize the target, wherein the second functional group of the aggregate inducers is free from being in contact with the metal nanoparticles, and is used to induce the metal nanoparticles to aggregate after the recognition molecules interact with the target.

### BACKGROUND OF THE INVENTION

1. Field of the Invention

The present invention relates to sensing platforms, and more particularly, to a sensing platform comprising metal nanoparticles modified by aggregation inducers and recognition molecules.

2. Description of Related Art

In the biotechnological and medical fields, as technologies rapidly advance, the use of specific marker molecules or specificity thereof to perform selective detections such as molecular biological detections has gradually become a major focus of research and development. Particularly, molecular biological detections of enzymes, nucleic acids, proteins or compounds that exist in trace amounts in vivo or in the environment can be performed with high specificity and high sensitivity. Molecular biological detections are extremely important in the medical, pharmacological and life sciences fields, for example, in early disease diagnoses, drug candidate selections and determination of environment factors. Therefore, the major trend of development in the fields is to develop detection methods that are highly sensitive, rapid, accurate and capable of handling a large sampling size and have lower production costs.

Recently, studies on the properties of metal nanoparticles have increased gradually. Particularly, there has been a substantial amount of research results on gold nanoparticles (hereinafter referred to as “AuNPs”) in chemical detections, biological detections, medical detections and biological imaging. It is known that when AuNPs are in a dispersed form, the color of the solution is between red and burgundy; and when AuNPs are in an aggregated form (i.e., the distances among AuNPs are less than the average diameter thereof), the color of the solution is changed to between indigo blue and purple black. The color change is observable by eyes, which is one of the advantages of the applications of AuNPs.

There have been reported on the application of AuNPs in a sensing platform. For example, US Patent publication No. 20080166706 disclosed a sensing platform comprising AuNPs and a shell comprising a sulfur-oxygen molecular species, wherein the AuNPs were selectively sized by using a notch filter and electromagnetic radiation. In this application, a quantum dot bond to the target to form a conjugate, and then the AuNPs bond to the conjugate for subsequent detection and measurement. A Raman scattering approach was employed to increase the magnitude of the signal by aggregation of the AuNPs. US Patent publication No. 20050059042 disclosed a method for sensing oligonucleotides by performing double detections involving coloring of AuNPs aggregated and labeling fluorescence on a single-stranded oligonucleotide probe, to determine the presence or absence of a target. In light of the prior art, AuNPs were only used to aid detections. Thus, both cases required additional markers, and further both caused fail to discuss the effects of AuNPs and modifiers thereof on the specificity to targets.

US Patent publication No. 20080089836 disclosed a nanoparticle with a bilayer structure, wherein the first layer, which was in direct contact with nanoparticles, comprises surface binding molecules comprising a hydrophobic moiety and a binding moiety, and the second layer comprises amphiphatic molecules, and the first and second layers were held together by hydrophobic interactions.

Moreover, there are also numerous research papers on the investigations of the properties of AuNPs in detections. For example, Liu et al. (see publication at Angew Chem Int Ed Engl. 2007, 46:8799-80) disclosed that after β-lactamase acted on a synthetic substrate to generate two sulfhydryl groups (—SH) on each end, the sulfhydryl groups then attracted AuNPs to aggregate and caused observable color changes, thereby detecting the presence or absence of a target enzyme. Nevertheless, the method cannot be conveniently applied as the synthesis of the substrate to be degraded to generate a mercapto (sulfhydryl) group was dependent on the target enzyme.

Wang et al. (see publication at J Am Chem Soc. 2006, 128:2214-2215) disclosed the AuNPs comprising a peptide substrate thereon for modifying biotin and AuNPs comprising albumin thereon, and the two AuNPs aggregated by specific bonding between biotin and albumin, thereby causing the AuNPs to generate a red shift. A change in optical density (O.D.) value was used as the basis of determination, to detect the enzyme that acts on the substrate. However, this type of detection relied upon that the two different types of molecules were respectively modified on the AuNPs. The procedure was complicated, and waveforms were prone to overlap due the size of the AuNPs.

Chen et al. (see publication at Langmuir 2008, 24:3654-3660) disclosed using human serum albumin (HSA) as a probe to modify AuNPs (i.e., HAS-AuNPs), and binding to lysozyme by electrostatic interactions to generate non-crosslinking aggregation by Van der Waals force, thereby causing a color change. The sensitivity of detection of HAS-AuNPs to lysozyme was dependent on HAS concentrations, and the selectivity can be significantly improved by changing solution pH values and salt concentrations. Zhao et al. (see publication at Chem Commun (Camb.) 2007, 36:3729-3731) disclosed using the non-crosslinking aggregation among AuNPs to detect a target. Further, Jena and Raj disclosed using reversible aggregation/dispersion to detect protamine and heparin.

Conventional technologies mainly use the principle in which AuNPs carry negative charges in detection applications, by allowing the AuNPs to aggregate by neutralizing negative charges thereof, and then use the degree of aggregation as basis for detection. However, detection results are prone to interference by the environment detected or the positive charge carried by a test sample, and AuNPs are affected by the environment detected and the pH value of the test sample. Hence, practical implementations of the conventional sensors comprising AuNPs are limited.

Therefore, there exists a need to develop a sensing platform and a detecting method capable of obtaining detection results with a lower production cost, easy operation and readiness to overcome the aforesaid drawbacks.

### SUMMARY OF INVENTION

In view of the aforesaid drawbacks of the conventional technologies, the present invention provides a sensing platform, comprising a plurality of metal nanoparticles; a plurality of aggregate inducers each comprising a first and a second functional groups, and the first functional group of the aggregate inducers being in contact with the metal nanoparticles; and a plurality of recognition molecules for binding the metal nanoparticles and for interacting with a target via the recognition molecules, wherein the second functional group of the aggregate inducers that is free from being in contact with the metal nanoparticles and is used to induce the metal nanoparticles to aggregate after the target interacts with the recognition molecules.

In a preferred embodiment of the sensing platform of the present invention, examples of the metal in the metal nanoparticles include, but are not limited to, the followings: gold, silver copper, aluminum, iron and nickel, wherein the metal nanoparticles can be made of a single metal or a combination of any two or more of the aforesaid metals. Alternatively, the metal nanoparticles each comprise a core and a metal shell made of any one of the aforesaid metals, and the metallic material of the shell is different from that of the metal core. Therefore, the metal nanoparticles each comprise one or more elements selected from the group consisting of gold, silver, copper, aluminum, iron or nickel. Preferably, a metal nanoparticle selected is one with an optical property that can be either a suspended form or an aggregated form in the environment. In one aspect, the metal nanoparticles are gold.

In the sensing platform of the present invention, the sizes of the metal nanoparticles are in nanometer (nm). Specifically, for instance, the diameters of the metal nanoparticles range from 5 to 60 nm.

In the sensing platform of the present invention, the aggregate inducers each have at least two functional groups (for example, at least two different functional groups), wherein one of the functional groups is in contact with the metal nanoparticles via a covalent bond. In a preferred embodiment, the aggregate inducers each comprise a first functional group and a second functional group different from one another, and the first and second functional groups are each selected from the group consisting of a hydroxyl group (—OH), a sulfhydryl group (—SH), an amino group (—NH₂) and a carboxyl group (—COOH).

In one aspect, the aggregate inducers each comprise a hydroxyl group (—OH) and a sulfhydryl group (—SH) at the same time.

Further, in one aspect, the aggregate inducers are 6-mercaptohexan-1-ol (HS(CH₂)₆OH, hereinafter referred to as “MCH”).

In the sensing platform of the present invention, the recognition molecules are determined based on the target to be marked. Persons having ordinary skills in the art can understand that there are no particular limitations on the recognition molecules, as long as the recognition molecules have specificity to the target and bind the metal nanoparticles. An example of the metal nanoparticles usually includes any one of the followings: an antibody, an antigen, an enzyme, an enzyme substrate, a nucleic acid, an amino acid, a protein, a lipid, a sugar, a lipopolysaccharide and a lipoprotein, but are not limited thereto, wherein in a non-limiting embodiment, the recognition molecules are preferably an enzyme substrate.

In an exemplary embodiment, the recognition molecules are completely or partially detached from the metal nanoparticles after the recognition molecules in the sensing platform reacts with the target, thereby reducing the steric hindrance among the metal nanoparticles. The aggregate inducers can use the other functional group that is in contact with the metal nanoparticles to induce the metal nanoparticles to aggregate by, for example, forming covalent bonds, thereby causing the metal nanoparticles to aggregate.

In an exemplary embodiment, the aggregate inducers and the recognition molecules are covalently bonded to the metal nanoparticles.

The sensing platform is not interfered by the positively charged metal ions present in the environment, and is stable in acidic, alkaline and highly saline environments. Therefore, as compared with conventional sensing platforms, the sensing platform of the present invention is more suitable for the application of detection of the presence of targets in acidic, alkaline and highly saline environments.

The present invention provides a method for preparing the aforesaid sensing platform, comprising the steps of: adding a solution of recognition molecules that uses a buffer solution as a solvent into a solution of metal nanoparticles, and oscillating the mixed solutions to allow the recognition molecules and the metal nanoparticles to bind to each other so as to obtain a mixture; and adding a solution of aggregate inducers into the resultant mixture, and oscillating the mixed solutions to allow a functional group of the aggregate inducers to be in contact with the metal nanoparticles to obtain a sensing platform comprising the metal nanoparticles modified by the recognition molecules and the aggregate inducers.

In one aspect, the metal nanoparticles are selected from gold, silver, copper, aluminum, iron and nickel. The metal nanoparticles may be made of a single metal, a combination of two or more of the aforesaid metals or an alloy of the aforesaid metals. Alternatively, the metal nanoparticles each comprise a metal core or shell comprising any one of the aforesaid metals, and the metal material of the shell is different from that of the metal core.

In one embodiment, the metal nanoparticles are gold.

In one embodiment, the recognition molecules are determined based on the target to be marked. Usually, the recognition molecules are ones selected from the group consisting of an antibody, an antigen, an enzyme, an enzyme substrate, a nucleic acid, an amino acid, a protein, a lipid, a sugar, a lipopolysaccharide and a lipoprotein.

In one embodiment, the aggregate inducers each have a first functional group and a second functional group different from one another, and the first and second functional groups are each selected from the group consisting of a hydroxyl group (—OH), a sulfhydryl group (—SH), an amino group (—NH₂) and a carboxyl group (—COOH).

In one embodiment, the concentration of the solution of metal nanoparticles used by the preparation method of the present invention may range from 0.5 to 50 nanomole/liter (nM), and preferably range from 1 to 10 nM; the concentration of the solution of recognition molecules may range from 0.1 to 10 milligram/milliliter (mg/mL), and preferably range from 0.5 to 5 mg/mL; and the concentration of the solution of aggregate inducers may range from 0.1 to 10 millimole/liter (mM), and preferably range from 0.5 to 5 mM.

More specifically, when the concentration of the solution of metal nanoparticles ranges from 0.5 to 50 nM and the concentration of the concentration of the solution of recognition molecules ranges from 0.1 to 10 mg/mL, the volume ratio of the solution of metal nanoparticles to the solution of recognition molecules ranges from 10:1 to 30:1, preferably ranges from 5:1 to 20:1, and is more preferably 19:1.

After the aforesaid recognition molecules bind with the metal nanoparticles to obtain a mixture, the solution of aggregate inducers is added to the mixture. When the concentration of the solution of the aggregate inducers ranges from 0.1 to 10 mM, the ratio of the solution of the aggregate inducers to the aforesaid mixture ranges from 1:60 to 1:200, preferably ranges from 1:60 to 1:150, and more preferably ranges from 1:80 to 1:140.

Moreover, the present invention also provides a method for detecting a target in a test solution, comprising the steps of: providing metal nanoparticles modified by aggregate inducers and recognition molecules, wherein the aggregate inducers each comprise a first and a second functional groups different from each other, the first functional group of the aggregate inducers is in contact with the metal nanoparticles, so as to allow the recognition molecules to interact with and thereby to recognize the target after the recognition molecules bind to the metal nanoparticles, and the second functional group of each of the aggregate inducers is free from being in contact with the metal nanoparticles, after the recognition molecules bind with the metal nanoparticle; allowing the test solution to be in contact with the metal nanoparticles; and measuring a change in the optical property of the test solution, and allowing the aggregate inducers to induce the metal nanoparticles to aggregate after the recognition molecules interact with the target, thereby causing changes in the optical property.

In the detection method of the present invention, the optical changes are color change and red shift in the absorption wavelength. Further, the optical changes can be observed by an eye and/or measured by an optical apparatus, such as spectrophotometer.

In one aspect, the metal nanoparticles are each selected from the group consisting of gold, silver copper, aluminum, iron and nickel. The metal nanoparticles can be made of a single metal or a combination of any two or more of the aforesaid metals. Alternatively, the metal nanoparticles each comprise a core and a metal shell made of any one of the aforesaid metals, and the metallic material of the shell is different from that of the metal core. A metal particle selected is one with an optical property that can be either a suspended form or an aggregated form in the environment.

In one aspect, the metal nanoparticles are made of gold, i.e., AuNPs. When detecting for the AuNPs modified by the aggregate inducers and the recognition molecules, the AuNPs in the suspended form has a color ranging from red to burgundy and the ones in the aggregated form has a color ranging from indigo blue to purple black. These color changes are usually observable by an eye, and the changes in waveforms can be measured by the spectrophotometer. In one aspect, the changes in waveforms are the changes in absorbance at wavelengths of 400 nm to 700 nm.

In one aspect, the optical changes are based on a ratio between a maximum absorption wavelength of 625 nm after the AuNPs aggregate and the original wavelength of 525 nm, so as to correct the error of waveform overlapping caused by changes in the sizes of the AuNPs.

In order to make the metal nanoparticles aggregate, the aggregate inducers each have a first functional group and a second functional group different from the first functional group. The first and second functional groups are each selected from the group consisting of a hydroxyl group (—OH), a sulfhydryl group (—SH), an amino group (—NH₂) and a carboxyl group (—COOH).

In a preferred embodiment, the aggregate inducers each comprise a hydroxyl group (—OH) and a sulfhydryl group (—SH) at the same time. Specifically, the aggregate inducers are 6-mercaptohexan-1-ol (HS(CH₂)₆OH, hereinafter referred to as “MCH”).

In a preferred embodiment, the recognition molecules are each selected from the group consisting of an antibody, an antigen, an enzyme, an enzyme substrate, a nucleic acid, an amino acid, a protein, a lipid, a sugar, a lipopolysaccharide and a lipoprotein.

The metal nanoparticles modified by the aggregate inducers and the recognition molecules are highly stable, which allows not only maintenance of long term stability, but also the capability to be widely applied in acidic, alkaline and highly saline environments.

As compared with conventional sensing platforms or detection methods, the reaction time required if the sensing platform or detection method provided by the present invention is used to detect the presence of a target is relatively shorter, and allows rapid obtaining of detection results. In implementation, the detection results can be obtained without use of a complex procedure or a precise apparatus, thereby substantially increasing the convenience of practical applications.

Furthermore, the metal nanoparticles used by the sensing platform or detection method provided by the present invention can be prepared by conventional methods in the art, for example, preparing AuNPs by reduction of sodium citrate, but are not limited thereto, to substantially lowering the production cost, thereby being beneficial for commercial-scale productions of the AuNPs.

### BRIEF DESCRIPTION OF THE DRAWINGS

FIG. 1 is a photograph of a sensing platform of the present invention that is shot by an electronic microscope, wherein FIG. 1A shows a suspended form of the AuNPs modified by gelatin and MCH (AuNPs/MCH-gelatin), and FIG. 1B shows an aggregated form of AuNPs/MCH-gelatin after interacting with MMP-2;

FIG. 2 shows the stability test results of the sensing platform of the present invention under different environmental conditions, wherein a solution of AuNPs/MCH-gelatin is measured under different environmental conductions and at absorption wavelengths ranging from 400 nm to 700 nm, ▴ represents a control group, Δ represents a strongly acidic condition, ∘ represents a strongly alkaline condition, and represents a highly alkaline condition;

FIGS. 3A to 3H show colorization results obtained by detections of the sensing platform of the present invention to the activities of different trypsin concentrations, wherein FIG. 3A represents a control group, FIG. 3B represents 1.25×10⁻³ U of trypsin, FIG. 3C represents 1.25×10⁻² U of trypsin, and FIG. 3D represents 1.25×10⁻¹ U of trypsin, FIG. 3E represents 1.25×10⁰ U of trypsin, FIG. 3F represents 1.25×10¹ U of trypsin, FIG. 3G represents 1.25×10² U of trypsin, and FIG. 3H represents 1.25×10³ U of trypsin;

FIG. 3I shows the relationship between the ratios (A₆₂₅/A₅₂₅) of the absorption wavelengths 625 nm and 525 nm for measurement and trypsin concentrations;

FIGS. 4A to 4F show results obtained in detections of the sensing platform of the present invention to the activities of different MMP-2 concentrations, wherein FIG. 4A represents a control group, FIG. 4B represents 0.02 U of MMP-2, FIG. 4C represents 0.04 U of MMP-2, FIG. 4D represents 0.08 U of MMP-2, FIG. 4E represents 0.1 U of MMP-2, and FIG. 4F represents 0.16 U of MMP-2;

FIG. 4G shows the relationship between ratios of the measured absorbance values at absorption wavelengths of 625 nm and 525 nm to MMP-2 concentrations;

FIG. 5A shows the detection results obtained by using MMPs suppressor, ONO-4817, in the sensing platform of the present invention to suppress MMP activity, wherein Δ represents a control group, ▴ represents 0.0125 nM of ONO-4817, ∘ represents 0.05 nM of ONO-4817, represents 2 nM of ONO-4817, □ represents

8 nM of ONO-4817, ▪ represents 32 nM of ONO-4817, ⋄ represents 128 nM of ONO-4817, and ♦ represents 512 nM of ONO-4817;

FIG. 5B shows the relationships between the ratios (A₆₂₅/A₅₂₅) of the absorption wavelengths 625 nm and 525 nm for measurement to ONO-4817 concentrations; and

FIG. 6 shows detection results of the specificity of protease suppressor at the ratios (A₆₂₅/A₅₂₅) of the absorption wavelengths 625 nm and 525 nm for measurement.

### DETAILED DESCRIPTION OF PREFERRED EMBODIMENTS

The following specific preferred embodiments illustrate the detailed description of the present invention. Persons skilled in the art can understand the other advantages and effects of the present invention based on the disclosure contained in the specification of the present invention.

In the following embodiment, the buffer solution used is one comprising 50 mM of NaCl (purchased from USB, Cleveland, USA), 50 mM of Tris-HCl (pH 7.5, purchased from Invitrogen, USA), 5 mM of CaCl₂ (purchased from Sigma-Aldrich, USA) and 0.05 v % of Triton X-100 (purchased from Sigma-Aldrich), unless specified otherwise.

### I. Preparation of a Sensing Platform

### (1) Preparation of AuNPs

An amount of 50 mL of HAuCl₄.3H₂O solution (1 mM) was heated to 130° C. in an oil bath, and 5 mL of sodium citrate (38.8 mM) was immediately added to the oil batch after the HAuCl₄.3H₂O solution boiled. Heating was stopped immediately when the color of the HAuCl₄.3H₂O solution turned red, so as to obtain a solution of AuNPs (having diameters ranging from about 5 to 60 nm).

### (2) Preparing of a Sensing Platform

Gelatin (purchased from Sigma-Aldrich) was dissolved in a buffer solution to prepare a 0.1 to 0.15 wt % gelatin solution.

950 μL of the solution of AuNPs (5 nM), 50 μL of the previously obtained gelatin solution (1 mg/mL) was added (allowing the solution of AuNPs and the gelatin solution to be mixed at a volume ratio of 19:1), and rapidly and thoroughly mixed the solution. The resultant mixture was placed in a controlled incubator to be vibrated at 37° C. for 2 hours, to obtain the gelatin-modified AuNPs (i.e., AuNPs-gelatin).

Subsequently, 10 μL of the MCH solution (1 mM) was added into the mixture (allowing the solution of the gelatin-modified AuNPs and the MCH solution to be mixed at a volume ratio of 100:1), and rapidly and thoroughly mixed the solution. The resultant mixture was placed in a controlled incubator to be vibrated at 37° C. for 2 hours.

Centrifuge was performed to remove unmodified AuNPs, unreacted gelatin and MCH. Sediments were collected and further dissolved in the buffer solution, to obtain the AuNPs modified by gelatin and MCH (i.e., AuNPs/MCH-gelatin) that have a maximum peak concentration OD₅₂₅=1.

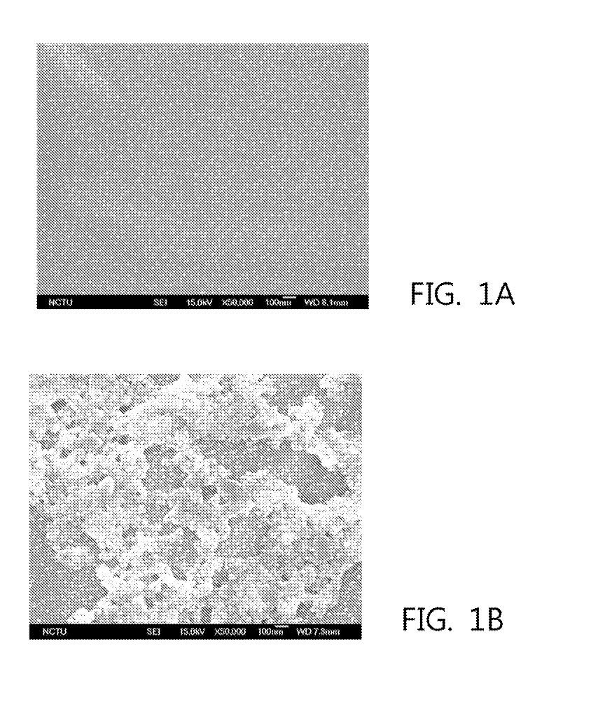

The above-obtained AuNPs/MCH-gelatin was placed under a scanning electronic microscope for observation, as shown in FIG. 1. FIG. 1A shows AuNPs/MCH-gelatin in the suspended form and does not aggregate, and FIG. 1B shows AuNPs/MCH-gelatin in an aggregated form, which is a type of AuNPs in the aggregated form that is obtained after reacting with matrix metalloproteinase-2 (abbreviated as “MMP-2”). Detailed steps are described later.

### II. Stability Test of Sensing Platform

### (1) A Control Group

In 200 μL of the solution of AuNPs/MCH-gelatin, 50 μL of 1×PBS buffer solution (comprising 137 mM of NaCl, 2.7 mM of KCl, 10 mM of Na₂HPO₄, and 2 mM of KH₂PO₄ at pH 7.4) was added to give a mixture. The mixture was placed in a water bath at 37° C. for 30 minutes, and a change in wavelength was measured by a spectrophotometer.

### (2) Under a Strongly Acidic Condition

In 200 μL of the solution of AuNPs/MCH-gelatin, 50 μL of 1 N hydrochloric acid (pH 1) was added to give a mixture. The mixture was placed in a water bath at 37° C. for 30 minutes, and a change in wavelength was measured by a spectrophotometer.

### (3) Under a Strongly Alkaline Condition

In 200 μL of the solution of AuNPs/MCH-gelatin, 50 μL of 1 N sodium hydroxide (pH 12) was added to give a mixture. The mixture was placed in a water bath at 37° C. for 30 minutes, and a change in wavelength was measured by a spectrophotometer.

### (4) Under a Highly Saline Condition

In 200 μL of the solution of AuNPs/MCH-gelatin, 50 μL of 10×PBS buffer (containing 1,370 mM of NaCl, 27 mM of KCl, 100 mM of Na₂HPO₄, and 20 mM of KH₂PO₄ at pH 7.4) was added to give a mixture. The mixture was placed in a water bath at 37° C. for 30 minutes, and a change in wavelength was measured by a spectrophotometer.

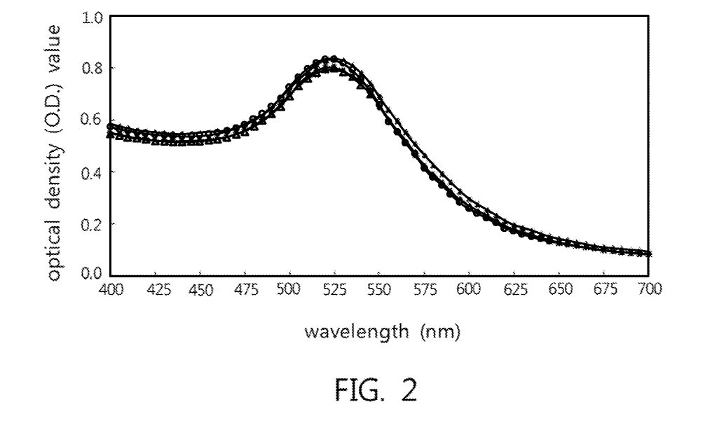

Results are shown in FIG. 2. As compared with the control group, when the sensing platform, not modified by proteinase, of the present invention functions, the solution of AuNPs/MCH-gelatin has a maximum absorption wavelength at 525 nm under strongly acidic, strongly basic and highly saline conditions, and the waveform does not change obviously. It appears that even when the sensing platform of the present invention functions under extreme conditions, AuNPs/MCH-gelatin can still remain suspended, instead of causing the gold particles to aggregate. This proves that the sensing platform of the present invention is highly stable.

### III. Activity Test of Proteinase

Different concentrations of trypsin were used for detection. A 10-fold dilution was performed on 1.25×10³ U of trypsin, to dilute it to 1.25×10⁻³ U. For each of the diluted trypsin, 50 μL of the diluted proteinase was added to 200 μL of the solution of AuNPs/MCH-gelatin to give a mixture. Mixtures were placed in a water bath at 37° C. to react for 10 minutes, and a change in wavelength was measured by a spectrophotometer. The groups were classified by their trypsin concentrations, and were labeled with a letter from A (the control group, trypsin concentration of zero) to H (trypsin concentration of 1.25×10³ U) in an ascending order of low to high trypsin concentrations.

The color change in the solution of AuNPs/MCH-gelatin becomes more obvious as the trypsin concentration of A gradually increases to that of H. Further, the color of the solution gradually changes from the red color observed in A to the purple color observed in H, and the color change can be identified by direct observations with an eye.

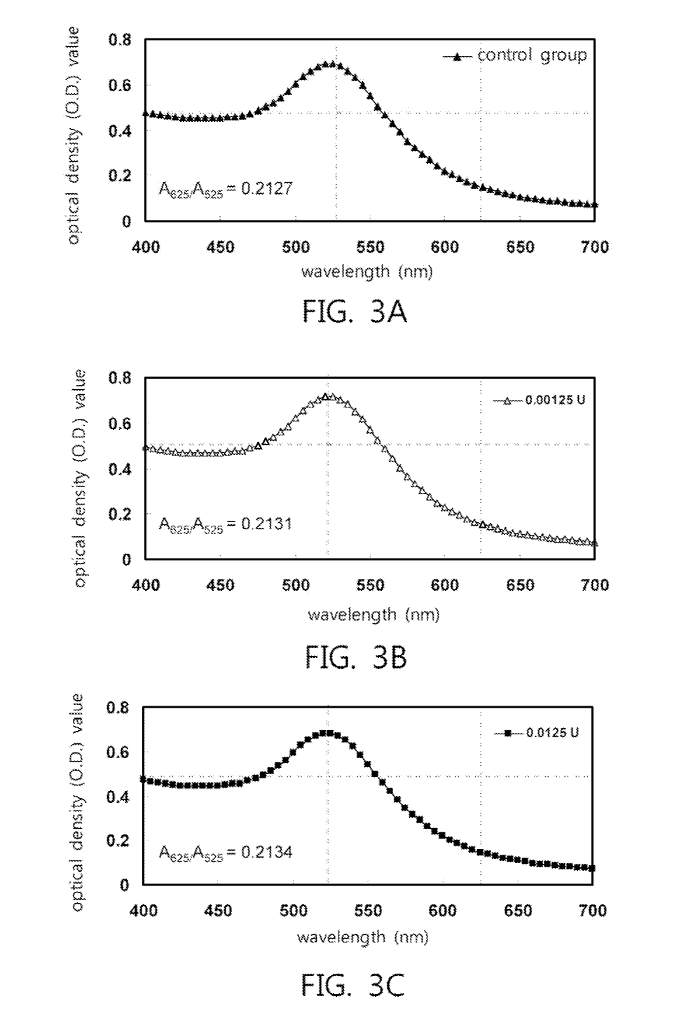

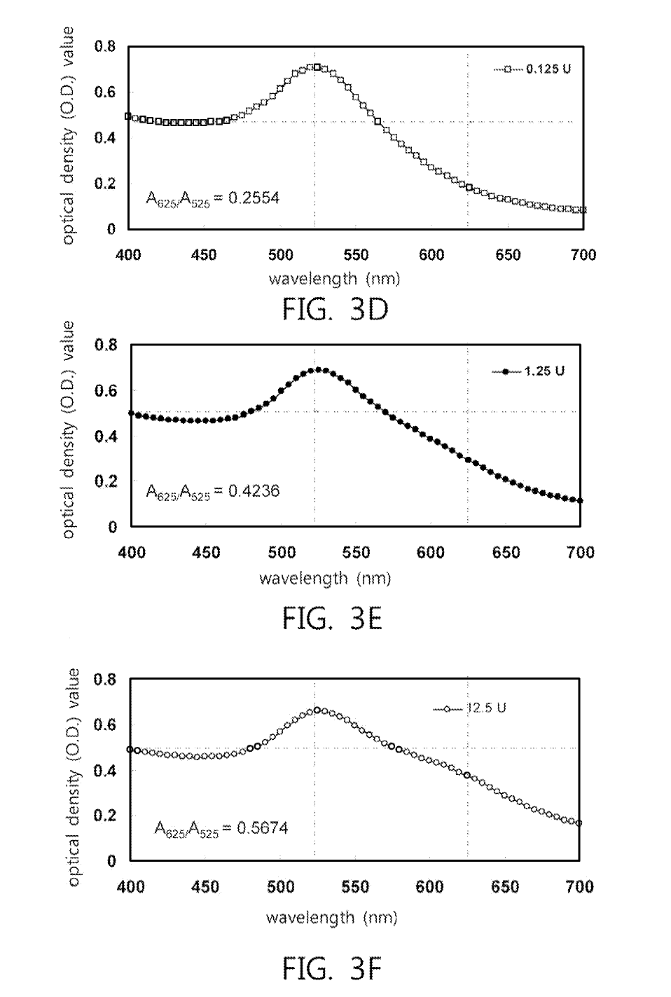

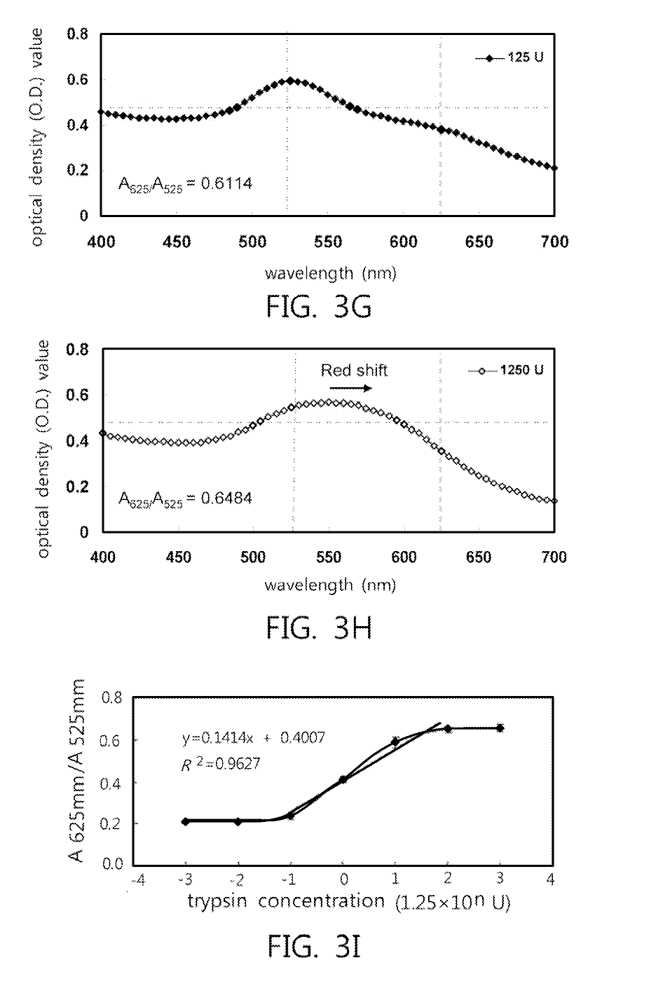

Results of the waveform changes measured by a spectrophotometer are shown in FIGS. 3A to 3H. As compared with the control group, when the sensing platform reacted with trypsin generates a waveform change, the optical absorption peak of the AuNPs generates a red shift.

Ratios (A₆₂₅/A₅₂₅) of the measured values at wavelengths of 625 nm and 525 nm are used as a basis for detection, so as to correct the error of waveform overlapping caused by changes to the sizes of the AuNPs. The ratios (A₆₂₅/A₅₂₅) of the groups are in the following: 0.2127 for A, 0.2131 for B, 0.2134 for C, 0.2554 for D, 0.4236 for E, 0.5674 for F, 0.6114 for G and 0.6484 for H. The ratios and the trypsin concentrations are shown in FIG. 3I, wherein when the trypsin concentrations are from 1.25×10⁻¹ U to 1.25×10² U, the wavelength changes and the trypsin concentrations are positively associated.

### IV. Application of the Sensing Platform of the Present Invention in Drug Selections

It is known that MMPs are an important factor in metastasis of cancer cells, and therefore MMPs suppressors suppress metastasis of cancer cells and can be used to develop drugs for treatment of cancer. ONO-4817 (purchased from Tocris, USA) is known as a generic MMPs suppressor, and its enzyme inhibition constants (Kᵢ) to various MMPs are the followings: 0.72 nM for MMP-2, 42 nM for MMP-3, 2,500 nM for MMP-7, 1.1 nM for MMP-8, 0.45 nM for MMP-12, 1.1 nM for MMP-13, and 2.1 nM for MMP-9. In the embodiment, uses MMP-2 and ONO-4817 are used to test the possibility of the application of the sensing platform of the present invention in drug selections.

### (1) Test of the Activity of MMP-2

For each of 0.16, 0.10, 0.08, 0.04 and 0.02 U of MMP-2 (purchased from Sigma-Aldrich, USA), 50 μL of MMP-2 was obtained added in the solution of AuNPs/MCH-gelatin to give a mixture. Mixtures were placed in a water bath at 37° C. to react for 30 minutes, and wavelength changes were measured with the spectrophotometer. The groups were classified by their MMP-2 concentrations, and were labeled with a letter from A (the control group, MMP-2 concentration of zero) to H (MMP-2 concentration of 0.02 U) in an ascending order of low to high MMP-2 concentrations.

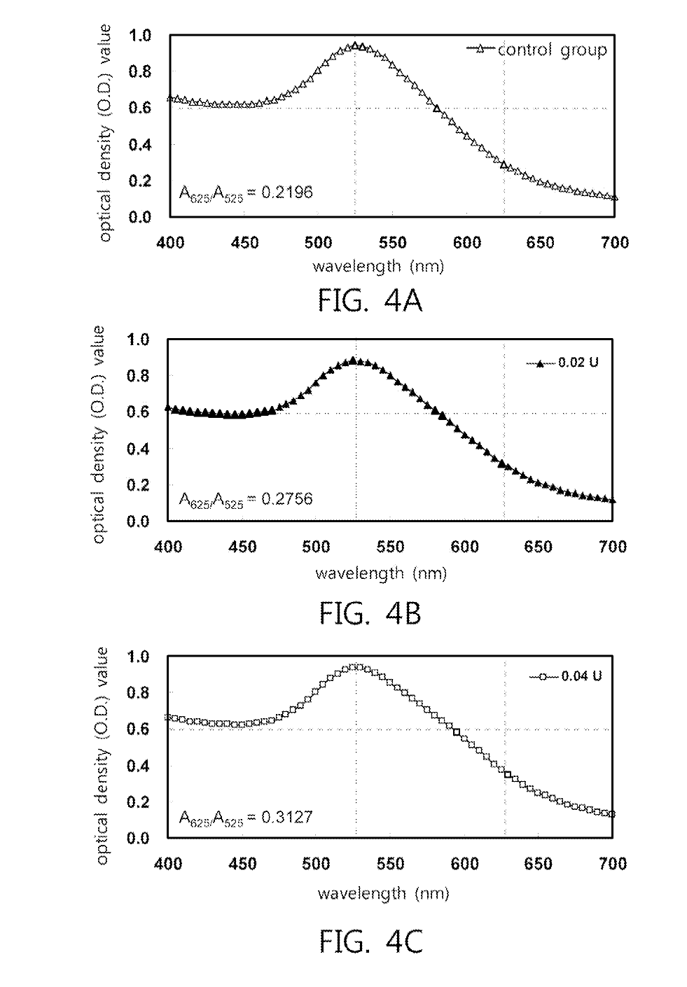

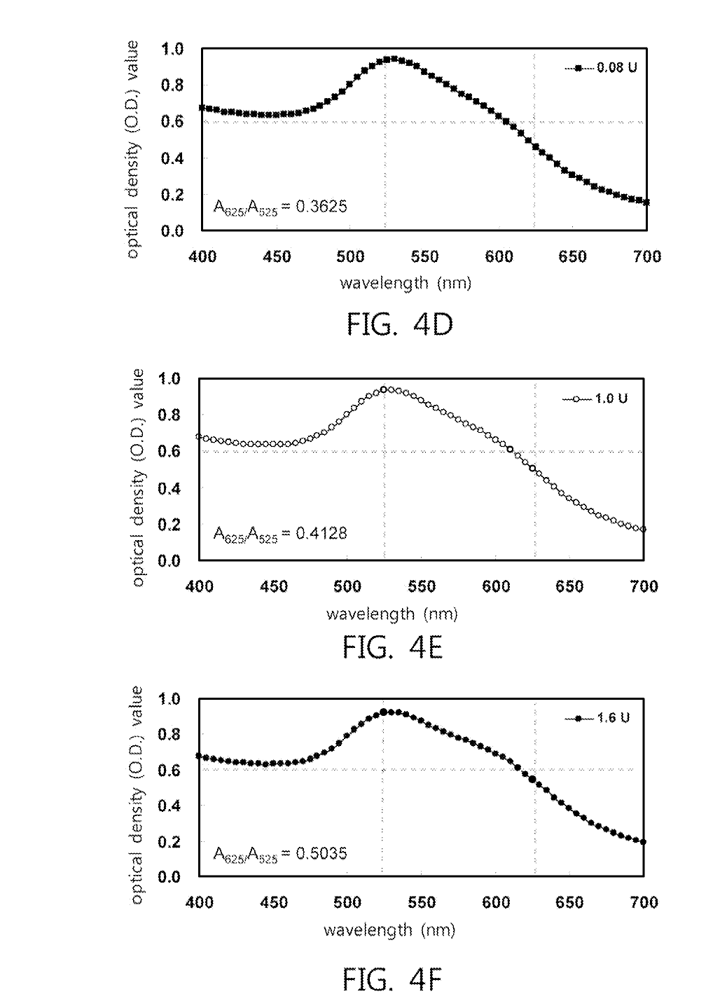

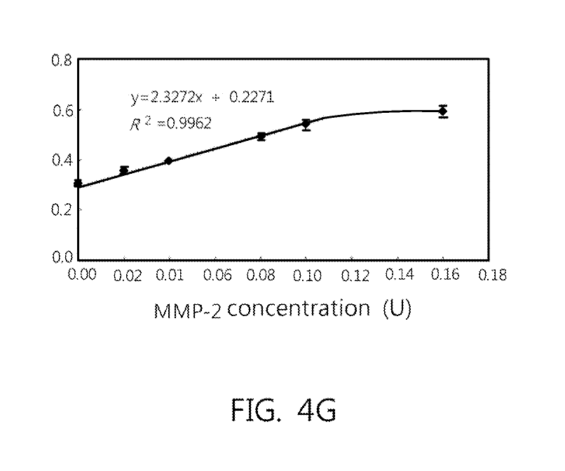

As shown in FIGS. 4A to 4F, after MMP-2 functions, the optical absorption waveform of the AuNPs of the sensing platform of the present invention generates a red shift. The A₆₂₅/A₅₂₅ values of the groups are in the following: 0.2196 for A, 0.2756 for B, 0.3127 for C, 0.3625 for D, 0.4128 for E and 0.5035 for F. FIG. 4G shows the relationship between the values and MMP-2 concentrations.

### (2) Test of the Activity of MMP-2 Suppressor

The MMP-2 suppressor ONO-4817 was used to perform a test. Buffer solutions containing different concentrations of ONO-4817 were added respectively into the solution of AuNPs/MCH-gelatin in a cuvette, and the concentrations of the solutions of AuNPs/MCH-gelatin were adjusted to give an OD₅₂₅=1.

For each of the aforesaid solution of AuNPs/MCH-gelatin, 0.5 μL of MMP-2 (100 ng/μL) was added in 200 μL of the solution of AuNPs/MCH-gelatin to give a mixture. Mixtures were placed in a water bath at 37° C. to react for 30 minutes, and the spectrophotometer was used to measure wavelength changes.

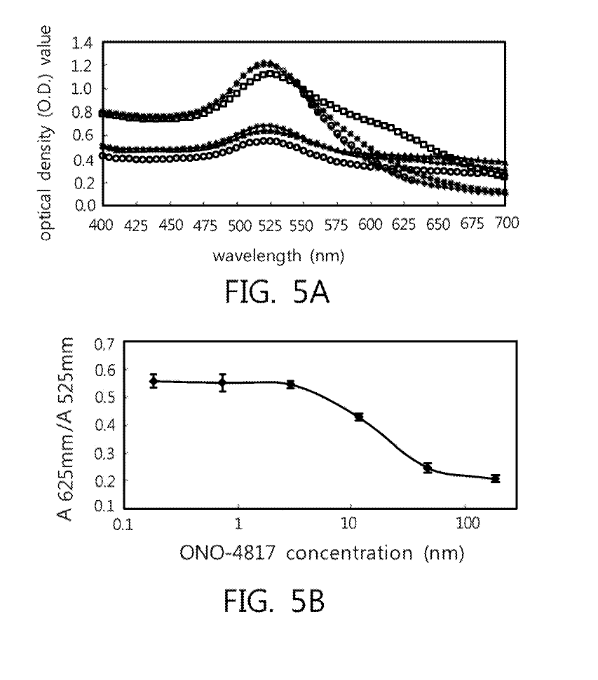

Results are shown in FIG. 5, wherein FIG. 5A shows the waveform changes of the sensing platform after the functioning of MMP-2 and ONO-4817, and FIG. 5B shows the relationship between the ratios (A₆₂₅/A₅₂₅) and ONO-4817 concentrations.

### (3) Test of Specificity of MMP-2 Suppressors

A specificity test is performed on the sensing platform of present invention using MMPs suppressors ONO-4817 and trypsin suppressors A1AT, wherein ONO-4817 cannot suppress the activity of trypsin, and A1AT cannot suppress the activity of MMPs.

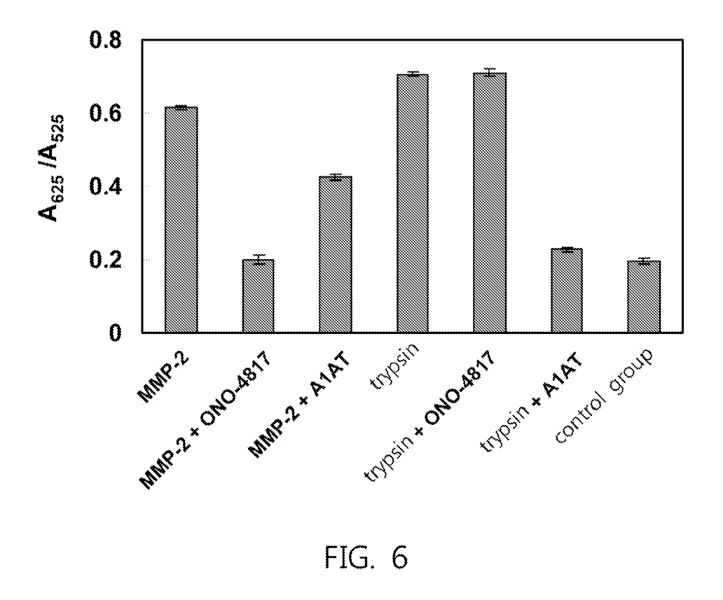

In 200 μL of the aforesaid solution of AuNPs/MCH-gelatin, 0.5 μL of solution of MMP-2 or trypsin (100 ng/μL) was added. Then, a solution of a highly concentrated proteinase suppressor ONO-4817 or A1AT (10 mM) was added to give a mixture. The mixture was placed in a water bath at 37° C. for 30 minutes to allow the reaction. A change in wavelength was measured by a spectrophotometer, and the ratios (A₆₂₅/A₅₂₅) of the values measured at wavelengths of 625 nm and 525 nm were calculated. Results are shown in FIG. 6.

As corroborated by the results shown in FIGS. 4 and 5, the substrates (i.e., gelatin) carried by AuNPs/MCH-gelatin interact with MMP-2 to dissociate from AuNPs, only when MMP-2 is present in the test samples. This shortens the distances among the AuNPs, and causes the AuNPs to aggregate, thereby changing waveforms. However, when ONO-4817 is present in the test samples, ONO-4817 can suppress the activity of MMP-2, and so the substrates carried by AuNPs/MCH-gelatin are not degraded by MMP-2. Thus, the AuNPs maintain a suspended form, and do not aggregate to cause a change in waveform of the sensing platform of the present invention.

As corroborated by the results shown in FIG. 6, when ONO-4817 is present in the test samples, ONO-4817 can suppress the activity of MMP-2. Thus, the substrates carried by AuNPs/MCH-gelatin are not degraded by MMP-2. The ratios (A₆₂₅/A₅₂₅) are not significantly different of the test samples are not significantly different from that of the control group. However, when A1AT is present in the test samples, MMP-2 can still degrade the substrates carried by AuNPs/MCH-gelatin as the activity of MMP-2 is not suppressed by A1AT, and causes the AuNPs to aggregate, thereby significantly increasing the ratios (A₆₂₅/A₅₂₅).

Similarly, A1AT can effectively suppress the activity of trypsin. Thus, when A1AT and trypsin are simultaneously present in the test samples, the ratios (A₆₂₅/A₅₂₅) of the test samples are similar to that of the control group, and when ONO-4817 is added to the test samples, the ratios (A₆₂₅/A₅₂₅) significantly increase in a manner similar to the ratios obtained by only adding trypsin. It is hence corroborated that the sensing platform employing AuNPs/MCH-gelatin, for application in selections of proteinase suppressors, clearly has specificity.

In conclusion, the sensing platform of the present invention is applicable in drug selections.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

1. A sensing platform, comprising:
a plurality of metal nanoparticles;
a plurality of aggregate inducers each comprising a first and a second functional groups different from each other, and the first functional group of the aggregate inducers being in contact with the metal nanoparticles; and
a plurality of recognition molecules for binding the metal nanoparticles and for interacting with a target so as to recognize the target,
wherein the second functional group of the aggregate inducers is free from being in contact with the metal nanoparticles, and is used to induce the metal nanoparticles to aggregate after the recognition molecules interact with the target.

2. The sensing platform of claim 1, wherein the metal nanoparticles comprise one or more elements selected from the group consisting of gold, silver, copper, aluminum, iron and nickel.

3. The sensing platform of claim 2, wherein the metal nanoparticles are gold.

4. The sensing platform of claim 1, wherein diameters of the metal nanoparticles ranges from 5 to 60 nm.

5. The sensing platform of claim 1, wherein each one of the first functional group and the second functional group different therefrom is a group selected from the group consisting of a hydroxyl group (—OH), a sulfhydryl group (—SH), an amino group (—NH₂) and a carboxyl group (—COOH).

6. The sensing platform of claim 1, wherein the aggregate inducers are 6-mercaptohexan-1-ol (HS(CH₂)₆OH).

7. The sensing platform of claim 1, wherein the recognition molecules are one selected from the group consisting of a free antibody, an antigen, an enzyme, an enzyme substrate, a nucleic acid, an amino acid, a protein, a lipid, a carbohydrate, a lipopolysaccharide and a glycoprotein.

8. A method for preparing a sensing platform of claim 1, comprising the steps of:
adding a solution of recognition molecules into a solution of metal nanoparticles, and oscillating the mixed solutions to allow the recognition molecules in the solution of the recognition molecules and the metal nanoparticles in the solution of the metal nanoparticles to bind to each other so as to obtain a mixture, in which the solution of recognition molecules contains a buffer solution as a solvent; and
adding a solution of aggregate inducers into the mixture, and oscillating the mixed solutions to allow a first functional group of each of the aggregate inducers in the solution of the aggregate inducers to be in contact with the metal nanoparticles so as to obtain the sensing platform of claim 1 comprising the metal nanoparticles modified by the recognition molecules and the aggregate inducers.

9. The method of claim 8, wherein the metal nanoparticles are gold.

10. The method of claim 8, wherein the aggregate inducers comprise the first functional group and a second functional group that is different from the first functional group, the first functional group and the second functional group each is one selected from the group consisting of a hydroxyl group (—OH), a sulfhydryl group (—SH), an amino group (—NH₂) and a carboxyl group (—COOH).

11. The method of claim 8, wherein the solution of the metal nanoparticles is at a concentration ranging from 0.5 to 50 nM, and the solution of recognition molecules is at a concentrating ranging from 0.1 to 10 mg/mL.

12. The method of claim 11, wherein the solution of metal nanoparticles and the solution of recognition molecules are at a volume ratio ranging from 10:1 to 30:1.

13. The method of claim 8, wherein the solution of aggregate inducers is at a concentration ranging from 0.1 to 10 mM.

14. The method of claim 13, wherein the aggregate inducers and the mixture of the solution of recognition molecules and the solution of metal nanoparticles are at a volume ration ranging from 1:60 to 1:200.

15. A method for detecting a target in a test solution, comprising the steps of:
providing metal nanoparticles modified by aggregate inducers and recognition molecules, in which the aggregate inducers each comprise a first and a second functional groups different from each other, the first functional group of each of the aggregate inducers is in contact with the metal nanoparticles, so as to allow the recognition molecules to interact with and thereby to recognize the target after the recognition molecules bind to the metal nanoparticles, and the second functional group of each of the aggregate inducers is free from being in contact with the metal nanoparticles, and is used to induce the metal nanoparticles to aggregate after the recognition molecules interact with the target;
allowing the test solution to be in contact with the metal nanoparticles; and
measuring an optical change of the test solution, and allowing the aggregate inducers to induce the metal nanoparticles to aggregate to generate a change in optical property after the recognition molecules interact specifically with the target.

16. The method of claim 15, wherein the optical change is observable by an eye and/or measured by an optical apparatus.

17. The method of claim 15, wherein the optical change is a color change.

18. The method of claim 15, wherein the metal nanoparticles are gold.

19. The method of claim 15, wherein the first functional group and the second functional group that is different from the first functional group, each is one selected from the group consisting of a hydroxyl group (—OH), a sulfhydryl group (—SH), an amino group (—NH₂) and a carboxyl group (—COOH).

20. The method of claim 15, wherein the aggregate inducers are 6-mercaptohexan-1-ol (HS(CH₂)₆OH).
